(19) United States
(12) Patent Application Publication
(10) Pub. No.: US 2004/0105400 A1
(43) Pub. Date: Jun. 3, 2004

(54) System and method for dormant control in the packet data service network

(75) Inventor: Hyo Sig Jean, Suwon-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/699,680

(22) Filed: Nov. 4, 2003

(30) Foreign Application Priority Data
Nov. 14, 2002 (KR) 10-2002-0070736

(51) Int. Cl. G08C 17/00

(52) U.S. Cl. 370/311

(57) ABSTRACT

A system and method for managing communications in a packet data service network includes activating a dormant function without determining a protocol standard used by a mobile station. This is accomplished by receiving a message from the mobile station which indicates that the mobile station supports the dormant function. The message may be a service connect complete message, a state response message issued in response to a state request message from a base station controller, or a message specially formed to notify a base station controller of whether the mobile station supports a dormant function. Through the transmission and subsequent processing of this message, call processing in a packet data service network is made faster and more efficient compared with other methods.

### BACKGROUND OF THE INVENTION

1. Field of the Invention

The present invention generally relates to communication systems, and more particularly to a system and method for managing communications between a mobile station and a packet data service network.

2. Background of the Related Art

FIG. 1 illustrates the structure of a related-art network for providing packet data service. Such a network comprises a mobile station 10, a base station transceiver subsystem 20, a base station controller 30, a mobile switching center 40, a packet control function (PCF) 50 and a packet data serving node (PDSN) 60.

The base station transceiver subsystem 20 comprises a base station processor (BSP) 21 and performs the function of a wireless interface to the mobile station.

The base station controller 30 is matched with the base station transceiver subsystem and with the mobile switching center. The base station controller conducts resource assignment, call control, hand-off control, power control and voice and packet process, etc.

The mobile switching center 40 is matched with the base station controller and conducts voice call switch control, call process, charging/authentication/subscriber information process, etc.

The PCF 50 conducts interface with the PDSN and conducts packet dormant process, etc.

The PDSN 60 is in charge of interfacing the packet data transmission of the fixed network with the packet data transmission of the wireless network. The PDSN performs this interface function with the mobile switching center through the PCF.

In the packet data service network described above, a packet data call may have three states: the active/connected state, the dormant state, and the null/inactive state.

In the active/connected state, there is a physical traffic channel between the mobile station and the base station controller. Data transmission is therefore possible. Also, for user traffic transmission, the interface between the base station controller and the mobile switching center, the interface between the base station controller and the PCF, and the interface between the PCF and the PDSN are maintained.

In the dormant state, there is no physical channel between the mobile station and the base station controller. In this state, a point-to-point protocol (PPP) link is maintained between the mobile station and the PDSN. The interface for the user traffic transmission between the base station controller and the mobile switching center and the interface for the user traffic transmission between the base station controller and the PCF are disconnected in this state. On the other hand, the interface for the user traffic transmission between the PCF and the PDSN is maintained.

In the null/inactive state, there is no physical traffic channel between the mobile station and the base station controller, nor is there any PPP link between the mobile station and the PDSN. In this state, there is no interface between the base station controller and the mobile switching center for the user traffic transmission. Further, there is no interface between the base station controller and the PCF, nor is there any interface between the PCF and the PDSN for the user traffic transmission.

The dormant state will be explained in further detail as follows. The “dormant function” means the function of releasing wireless resources under the base station controller if there is no packet data transmitted or received for certain period of time to thereby increase the utility of resources, and of reassigning wireless resources only if there arises packet data transmission and thus reinitiating the packet data service. The transmission of the packet data call is discontinuous in terms of time or quantity and has the burst characteristic. Thus, the above-described dormant function is very useful for efficient management of resources.

The dormant function performs state transition of the packet data service from the active/connected state to the dormant state. If a packet data service user is temporarily in a state where the service is not provided for that user, through the dormant function the system collects the wireless resources which were assigned to the relevant user so that such resources may be assigned to other users. Further, the dormant function makes it possible for the mobile station and the packet data service network to share TCP/IP transmission Control Protocol/Internet Protocol) specification information in order to shorten the call connection time required while conducting the TCP/IP assignment action. In addition, if the user whose wireless resources have been collected by the dormant function requests re-connection, the dormant function makes quick re-connection possible by using the TCP/IP specification information.

The dormant function has been provided for in the Protocol Revision 4 of IS-95B. This function should be provided as a basis in a mobile station supporting IS-95B or the higher versions of this standard The system providing packet data services for mobile stations of IS-95B or IS-95C or higher must provide the dormant function while providing such packet data services.

However, there are cases where certain IS-95A protocol revisions provide the dormant function and where certain IS-95B or higher ones do not provide the dormant function. In such cases, if a mobile station requests packet data services, because the technology in the related art could not determine whether the mobile station requesting the packet data services provides the dormant function or not (i.e., because the technology in the related art could not distinguish a mobile station where the dormant function is applied from other mobile stations where the dormant function is not applied), the dormant function could not be effectively provided.

### SUMMARY OF THE INVENTION

An object of the invention is to solve at least the above problems and/or disadvantages and to provide at least the advantages described hereinafter.

Another object of the present invention is to provide an improved system and method for managing the processing of calls in a packet data service network

Another object of the present invention is to provide a dormant control system in a packet data service network and a method therefore, through which the packet data service requested by a mobile station is processed upon determining whether the mobile station is the one for which the dormant function is applicable.

If a mobile station where the dormant function is applied and a mobile station where the dormant function is not applied request the packet data service to the system of the same version in the packet data service network, the present invention attempts to provide the dormant function only for the mobile station where the dormant function is applied upon confirming whether the dormant function is applicable to the relevant mobile station.

Moreover, by receiving a specific message including information concerning the dormant function performance from the relevant mobile station in the packet data service network and thus determining whether the dormant function will be applied to the relevant mobile station or not upon referring to the information contained in the message, the present invention attempts to easily confirm whether a mobile station is one where the dormant function is applicable by simply referring to the information in said specific message and to provide the dormant function to that mobile station.

To achieve these and other objects and advantages, the present invention provides in accordance with one embodiment a dormant control system in a packet data service network comprising: a mobile station that provides information concerning whether it supports the dormant function by using a specific message; and a base station controller that receives the specific message from the mobile station and determines whether to conduct the dormant function.

Preferably, the specific message is a message that is essentially used between the mobile station and the base station controller or a message that is basically provided between the mobile station and the base station controller. Further, the specific message indicates whether the mobile station supports the dormant function or not by using a field that is not used otherwise in said specific message. Further, the message that is used essentially is the service connect complete message received from the mobile station. The message that is provided basically is the mobile station's state response message that is provided in response to the state request message of the base station controller.

Alternatively, the specific message is a separate notice message concerning dormant function support through which the mobile station indicates whether it supports the dormant function or not.

Preferably, the base station controller comprises: a call control processor (CCP) that transmits information related to the dormant control and service option information of the mobile station if it receives a mobile origination message from the mobile station through the base station transceiver subsystem; and a selection and distribution unit (SDU) that reviews the service option information and the timer information received from the CCP and, if the packet data service option is indicated in the received information, prepares for the determination of whether the mobile station supports the dormant function, generates a service connection message and transmits it to the mobile station, upon receiving the specific message from the mobile station and confirming the information on whether the dormant function is supported, drives the dormant timer, and upon determining whether the mobile station supports the dormant function by confirming the driving of the dormant timer in the active/connected state, conducts the dormant function.

In accordance with another embodiment, the present invention provides a dormant control method in the packet data service network comprising: transmitting information on whether the relevant mobile station supports the dormant function in the packet data service network by using a certain message in between the mobile station and the base station controller, and upon receiving the message, confirming whether the mobile station supports the dormant function and then providing the dormant function.

Preferably, the certain message is a message that is essentially used in between the mobile station and the base station controller or a message that is basically provided in between the mobile station and the base station controller. Further, the certain message indicates in the remainder area in the message whether the relevant mobile station supports the dormant function or not. The message used essentially is a service connect complete message received from the mobile station. The message provided basically is a state response message of the mobile station sent in response to a state request message of the base station controller. The service connect complete message comprises fields for message type, acknowledgement sequence number, message sequence number, acknowledgement required indicator, message encryption indicator, dormant support information, service connection sequence number and the reserved field.

Alternatively, the certain message is a separate dormant support notice message for indicating whether the mobile station supports the dormant function or not. Further, said dormant support notice message comprises fields for information on whether the dormant function is supported and service connection sequence number.

Further, preferably the provision of the dormant function comprises: analyzing at the base station controller the dormant support information within the certain message received from the mobile station; if it is determined that the mobile station supports the dormant function, driving at the base station controller a dormant timer; requesting at the base station controller for interface registration in order to transmit signaling information to the PDSN, receiving a response thereto and then notifying the mobile switching center of completion of the resource assignment; establishing the PPP connection between the mobile station and the PDSN and conducting the mobile IP registration procedure, thereby transmitting and receiving packet data in the active/connected state; and determining at the base station controller whether the dormant timer is in operation and if there has been no packet data transmission within the specified time of the dormant timer, making transition to the dormant state from the active/connected state.

Preferably, the provision of the dormant function further comprises, if it is determined that the mobile station does not support the dormant function, refraining at the base station controller from driving the dormant timer, thereby maintaining the active/connected state.

A dormant control method in the packet data service network according to another preferred embodiment of the present invention comprises: transmitting a service connect complete message including information on whether the mobile station supports the dormant function or not in the packet data service network; and upon receiving the service connect complete message at the base station controller and analyzing whether the mobile station supports the dormant function, driving the dormant timer, and when packet data is transmitted and received in the active/connected state, determining whether the dormant timer is in operation and providing the dormant function.

Preferably, the transmission of a service connect complete message comprises: if the base station controller receives a mobile origination message from the mobile station, sending service request to the mobile switching center and then upon receiving the resource assignment request, requesting the base station transceiver subsystem to assign resources, thereby assigning resources; upon reviewing the mobile station's service option information received at the base station controller through the base station transceiver subsystem and the dormant timer information, if it is the packet data service option, preparing for determination on whether the mobile station supports the dormant function; transmitting at the base station controller a expanded channel assignment message to the mobile station through the base station transceiver subsystem and then transmitting a service connection message to the mobile station; and generating at the mobile station the service connect complete message, adding the dormant support information thereto and transmitting it to the base station controller.

Further, preferably the provision of the dormant function comprises: analyzing at the base station controller the dormant support information included in the service connect complete message received from the mobile station; if it is determined that the mobile station supports the dormant function, driving the dormant timer at the base station controller; sending at the base station controller an interface registration request to the PDSN for transmission of signaling information and then receiving a response thereto and notifying the mobile switching center of the resource assignment completion; establishing the PPP connection between the mobile station and the PDSN and conducting the mobile IP registration procedure, thus transmitting and receiving packet data in the active/connected state; and determining at the base station controller whether the dormant timer is in operation and if no packet data has been transmitted within the specified value of the dormant timer, making a transition from the active/connected state to the dormant state.

Further, preferably the provision of the dormant function further comprises, if it is determined that the mobile station does not support the dormant function, refraining at the base station controller from driving the dormant timer, thus maintaining the active/connected state.

Additional advantages, objects and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is a block diagram illustrating the structure of a network for providing the packet data service in the related art.

FIG. 2 is a block diagram illustrating the structure for the dormant control in the packet data service network according to the present invention.

FIG. 3 is a flow diagram illustrating a dormant control method in the packet data service network according to the present invention.

FIG. 4 illustrates an example format of the service connect complete message of FIG. 3.

FIG. 5 illustrates another example format of the service connect complete message of FIG. 3.

### DETAILED DESCRIPTION OF PREFERRED EMBODIMENTS

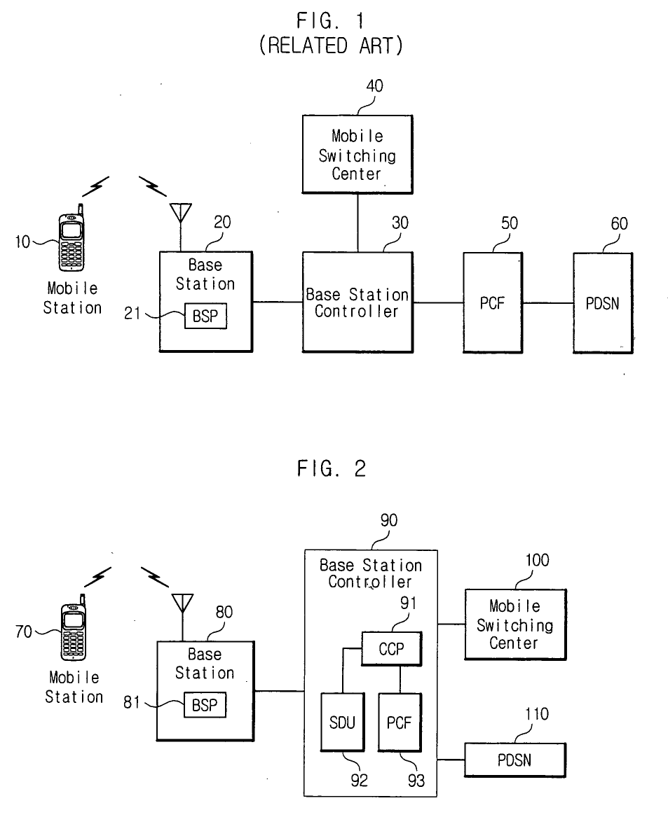

As illustrated in FIG. 2, a dormant control system in the packet data service network according to a preferred embodiment of the present invention comprises: a mobile station 70, a base station transceiver subsystem 80, a base station controller 90, a mobile switching center 100 and a PDSN 110. The base station transceiver subsystem 80, the mobile switching center 100 and the PDSN 110 may correspond to the same ones shown in related art FIG. 1.

The mobile station 70 transmits information on whether it supports the dormant function in the packet data service network to the base station controller 90 through the base station transceiver subsystem 80 by using specific information within a certain message. Preferably, the certain message is a message used essentially in between the mobile station 70 and the base station controller 90 (e.g., a service connect complete message from the mobile station 70) or a message provided basically in between the mobile station 70 and the base station controller 90 (e.g., a state response message of the mobile station 70 issued in response to a state request message of the base station controller 90).

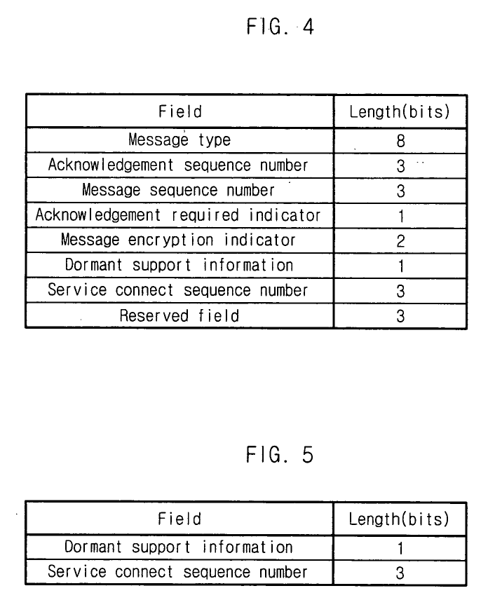

Further, the specific information in the certain message uses a field that is not used otherwise in the message. For example, as illustrated in FIG. 4, the reserved field m a service connect complete message may be used for this purpose. By transmitting ‘0’ or ‘1’ as the value of the specific information, it may be indicated whether the mobile station supports the dormant function. Specifically, if the transmitted information is ‘0’, it means that the mobile station does not support the dormant function. If the transmitted information is ‘1’, it means that the mobile station supports the dormant function.

Alternatively, as illustrated in FIG. 5, the certain message may be a separate dormant support notice message providing information on whether the mobile station 70 itself supports the dormant function or not.

The base station controller 90 is matched with the mobile station transceiver subsystem 80 and with the mobile switching center 100. It conducts resource assignment, call control, hand-off control, power control, voice packet process, and packet dormant control functions, etc. Especially, by receiving the dormant support information of the mobile station 70 through the base station transceiver subsystem 80 and by using the specific information within said certain message on the dormant function, the base station controller 90 determines whether to conduct the dormant function simply by referring to the specific information without referring to the protocol revision information.

The base station controller 90 comprises: a CCP 91 conducting resource assignment, call control, hand-off control, power control, and voice and packet process, etc; an SDU 92 conducting the dormant function; and a PCF 93 conducting the interface with the PDSN 110.

If a mobile origination message is received from the mobile station 70 through the base station transceiver subsystem 80, the CCP 91 transmits the information concerning the dormant control and the service option information of the mobile station 70 to the SDU 92.

The SDU 92 reviews the mobile station's service option information received from the CCP 91 and the dormant timer information, and if it indicates that the option is the packet data service option prepares for determination on whether the mobile station supports the dormant function. Further, upon receiving the dormant support notice message from the mobile station or receiving a service connect complete message from the mobile station after generating a service connect message and transmitting it to the mobile station, the SDU 92 confirms whether the dormant function is supported or not and drives the dormant timer. Also, the SDU 92 checks whether the dormant timer is in operation in the active/connected state and thus determines whether the mobile station supports the dormant function and then conducts the dormant function.

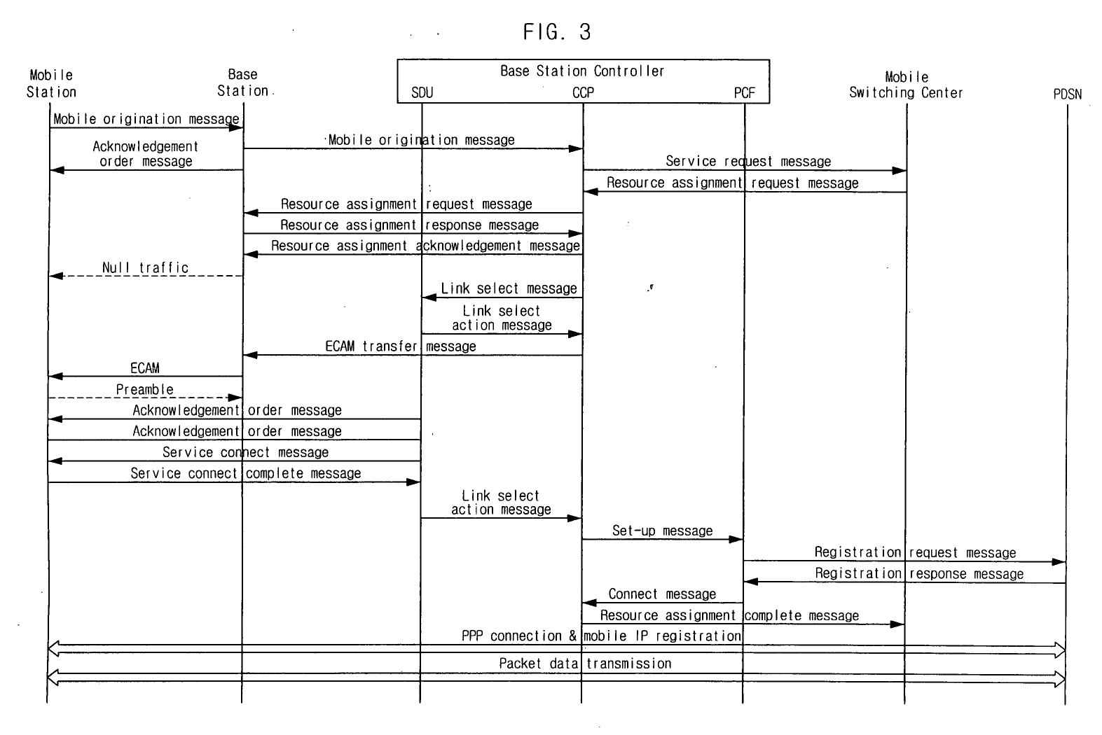

A dormant control method in the packet data service network according to a preferred embodiment of the present invention will now be explained with references to FIG. 3.

First, when the mobile station 70 transmits a mobile origination message to the base station transceiver subsystem 80 through an access channel, the BSP 81 within the base station transceiver subsystem 80 receives the mobile origination message from the mobile station 70, generates an acknowledgement order message (bs_ack_order) and transmits it to the mobile station 70 through a paging channel. At the same time, the BSP 81 transmits the mobile origination message (MobOrg_B2C) to the base station controller 90.

Then, the CCP 91 within the base station controller 90 receives the mobile origination message (MobOrg_B2C) from the base station transceiver subsystem 80, builds a service request message (CM Service Request_C2M) and transmits it to the mobile switching center 100. Thereafter, within certain predetermined time, the CCP 91 receives a resource assignment request message (Assignment Request_M2C) from the mobile switching center 100.

Also, after generating a resource assignment request message (AssgnReq_C2B) and transmitting it to the base station transceiver subsystem 80, if the CCP 91 within the base station controller 90 receives a response message (AssgnRep_B2C) from the BSP 81 within the base station transceiver subsystem 80, it generates a resource assignment acknowledge message (AssgnAck_C2B) and transmits it to the base station transceiver subsystem 80.

Accordingly, the BSP 81 within the base station transceiver subsystem 80 receives a resource assignment acknowledgement message (AssgnAck_C2B) from the base station controller, generates a null traffic message (null_traffic) and transmits it to the mobile station 70.

Thereafter, the CCP 91 within the base station controller 90 generates a link select message (SelTcLink_C2S), includes the dormant support information and the service option information in the link select message (SelTcLink_C2S) and transmits it to the SDU 92 within the base station controller 90.

Then, the SDU 92 within the base station controller 90 checks the link select message (SelTcLink_C2S) received from the CCP 91 and reviews the mobile station 70's service option information and the dormant timer information. If the service option information indicates the packet data service option, the SDU 92 prepares for determination on whether the mobile station 70 supports the dormant function or not and then generates a link select action message (SelTcLinkAct_S2C) in response to the link select message (SelTcLink_C2S) and sends it to the CCP 91.

Accordingly, the CCP 91 within the base station controller 90 generates a transmission message (Ab_ECAM Transfer) of an extended channel assignment Message (ECAM) for assignment of an extended channel and transmits it to the base station transceiver subsystem 80.

Then, the BSP 81 within the base station transceiver subsystem 80 receives the ECAM transfer message (Ab_ECAM Transfer) from the base station controller 90, generates the ECAM and transmits it to the mobile station 70. Thereafter, the BSP 81 receives a preamble message (Preamble) from the mobile station 70.

On the other hand, the SDU 92 within the base station controller 90, after transmitting the link select action message (SelTcLinkAct_S2C) to the CCP 91, generates an acknowledgement order message (bs_ack_order) and transmits it to the mobile station 70.

Thereafter, if the SDU 92 within the base station controller 90 receives an acknowledgement order message (ms_ack_order) from the mobile station, it generates a service connect message (so_connect) and transmits it to the mobile station 70. Then, in response thereto, the SDU 92 receives a service connect complete message (so_complete) from the mobile station 70.

Preferably, the mobile station 70 inserts the dormant support information within the service connect complete message (so_complete) and transmits it to the SDU 92 within the base station controller 90. In other words, the mobile station 70 inserts the information on whether the mobile station 70 itself supports the dormant function or not within the service connect complete message.

The format of the service connect complete message (so_complete) is illustrated in FIG. 4. As illustrated in FIG. 4, the service connect complete message comprises: 8 bits of message type; 3 bits of an acknowledgement sequence number, 1 bit of an acknowledgement required indicator; 2 bits of a message encryption indicator; 1 bit of dormant support information; 3 bits of a service connect sequence number, and 3 bits of a reserved field.

Alternatively, the mobile station 70 generates a certain message (i.e., the dormant support notice message) containing the information on whether the mobile station 70 itself supports the dormant function and transmits it to the SDU 92 within the base station controller 90.

Preferably, as illustrated in FIG. 5, the dormant support notice message comprises: 1 bit of dormant support information; and 3 bits of a service connect sequence number. The dormant support information would be either ‘0’ or ‘1’. If the dormant support information is ‘0’, it means that the mobile station supports the dormant function. If the dormant support information is ‘1’, it means that the mobile station does not support the dormant function.

Then, the SDU 92 within the base station controller 90 checks the service connect complete message (so_complete) or the dormant support notice message received from the mobile station 70 and analyzes whether the dormant function is supported. In other words, it is confirmed whether the mobile station 70 supports the dormant function or not.

If the mobile station 70 supports the dormant function, the dormant timer is driven for provision of the dormant function. In contrast, if the mobile station 70 does not support the dormant function, the dormant timer is not driven and thus the dormant function is not provided.

Further, the SDU 92 within the base station controller 90 generates a link select action message (MsSelLinkAct_S2C) and transmits it to the CCP 91 within the base station controller 90. Accordingly, the CCP 91 generates a set-up message (Setup) for setting up the interface for transmission of user traffic to and from the PCF 93 within the base station controller 90 and the interface for transmitting signaling information to and from the PCF 93, and transmits the set-up message (Setup) to the PCF 93.

Then, the PCF 93 within the base station controller 90 generates a registration request message (Registration Request) for registration of the interface for transmitting signaling information to and from the PDSN 110 and transmits it to the PDSN 11. Thereafter, the PCF receives a reply thereto (Registration Reply) from the PDSN 11.

Thereupon, the PCF 93 within the base station controller 90 generates a connect message (Connect) to interface the CCP 91 within the base station controller 91 for the transmission of user traffic and to interface the CCP 91 for the transmission of signaling information, and transmits the connect message (Connect) to the CCP 91.

The CCP 91 within the base station controller 90 generates the resource assignment complete message (AssgnCmpl_C2M) and transmits it to the mobile switching center 100. Thereby, the CCP 91 establishes the PPP connection between the mobile station 70 and the PDSN 110 and conducts the mobile IP registration procedure. Thus, it becomes the active/connected state wherein the packet data may be transmitted and received.

Then, the SDU 92 within the base station controller 90 determines whether the dormant timer is in operation. If the dormant timer is in operation, it is determined that the mobile station 70 supports the dormant function. Thus, the volume of packet data transmitted from the PDSN is measured. If there is no packet data transmission within certain time value specified in the dormant timer, a transition is made from the active/connected state to the dormant state. If at least one packet data is received, the dormant timer is initialized and re-driven. This action is repeated.

On the other hand, if the dormant timer is not in operation, it is determined that the mobile station 70 does not support the dormant function. Thus, even if there is no packet data within certain time value specified in the dormant timer, the active/connected state is not changed to the dormant state. In other words, the active/connected state is maintained.

As described above, according to the present invention, information concerning whether a mobile station in the packet data service network supports a dormant function or not is transmitted within a specific message and such information is referred to in determining whether the dormant function is to be applied to the relevant mobile station. Thus, according to the present invention, the dormant function may be provided upon confirming whether the dormant function may be applied to the relevant mobile station easily even without referring to the protocol revision information.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A dormant control system in a packet data service network comprising:
a mobile station that provides information indicating whether the mobile station supports a dormant function using a specific message; and
a base station controller that receives the specific message from the mobile station and determines whether to conduct the dormant function.

2. The dormant control system according to claim 1, wherein the specific message is a message used between the mobile station and the base station controller or a message that is provided between the mobile station and the base station controller.

3. The dormant control system according to claim 2, wherein said specific message indicates whether the mobile station supports the dormant function or not by using a field that is not used otherwise in said specific message.

4. The dormant control system according to claim 2, wherein the message that is used between the mobile station an the base station controller is a service connect complete message received from the mobile station and the message that is provided between the mobile station and the base station controller is a mobile station's state response message that is provided in response to the state request message of the base station controller.

5. The dormant control system according to claim 1, wherein said specific message is a separate notice message concerning dormant function support through which the mobile station indicates whether the mobile station supports the dormant function or not.

6. The dormant control system according to claim 1, wherein the base station controller comprises:
a call control processor (CCP) that transmits information related to dormant control and service option information of the mobile station if a mobile origination message is received from the mobile station through the base station transceiver subsystem; and
a selection and distribution unit (SDU) that reviews the service option information and timer information received from the CCP, and if the packet data service option is indicated in the received information prepares for determination of whether the mobile station supports the dormant function, generates a service connection message and transmits the service connection message to the mobile station, upon receiving the specific message from the mobile station and confirming the information on whether the dormant function is supported, drives the dormant timer, and upon determining whether the mobile station supports the dormant function by confirming the driving of the dormant timer in the active/connected state, conducts the dormant function.

7. A dormant control method in a packet data service network comprising:
transmitting information on whether a mobile station supports a dormant function in the packet data service network using a certain message between the mobile station and a base station controller, and
upon receiving the certain message, confirming whether the mobile station supports the dormant function and then providing the dormant function.

8. The dormant control method according to claim 7, wherein the certain message is a message that is used between the mobile station and the base station controller or a message that is provided between the mobile station and the base station controller.

9. The dormant control method in the packet data service network according to claim 8, wherein the certain message indicates in the reserved field of the message whether the relevant mobile station supports the dormant function or not.

10. The dormant control method in the packet data service network according to claim 8, wherein the message used between the mobile station and base station controller is a service connect complete message received from the mobile station and the message provided between the mobile station and base station controller is a state response message of the mobile station sent in response to a state request message of the base station controller.

11. The dormant control method according to claim 10, wherein said service connect complete message comprises fields for message type, acknowledgement sequence number, message sequence number, acknowledgement required indicator, message encryption indicator, dormant support information, service connection sequence number and a reserved field.

12. The dormant control method according to claim 7, wherein the certain message is a separate dormant support notice message that the mobile station uses to indicate whether the mobile station itself supports the dormant function or not.

13. The dormant control method according to claim 12, wherein said dormant support notice message comprises fields for information on whether the dormant function is supported and service connection sequence number.

14. The dormant control method according to claim 7, wherein said provision of the dormant function comprises:
analyzing at the base station controller dormant support information within the certain message received from the mobile station;
if it is determined that the mobile station supports the dormant function, driving at the base station controller a dormant timer,
requesting at the base station controller for interface registration in order to transmit signaling information to a PDSN, receiving a response thereto and then notifying the mobile switching center of completion of the resource assignment;
establishing a PPP connection between the mobile station and the PDSN and conducting a mobile IP registration procedure, thereby transmitting and receiving packet data in an active/connected state; and
determining at the base station controller whether the dormant timer is in operation and if there has been no packet data transmission within the specified time of the dormant timer, making transition to the dormant state from the active/connected state.

15. The dormant control method according to claim 14, wherein said provision of the dormant function further comprises, if it is determined that the mobile station does not support the dormant function, refraining at the base station controller from driving the dormant timer, thereby maintaining the active/connected state.

16. A dormant control method in the packet data service network, comprising:
transmitting a service connect complete message including information on whether the mobile station supports the dormant function or not in the packet data service network; and
upon receiving the service connect complete message at the base station controller and analyzing whether the mobile station supports the dormant function, driving a dormant timer, and when packet data is transmitted and received in the active/connected state, determining whether the dormant timer is in operation and providing the dormant function.

17. The dormant control method according to claim 16, wherein said transmission of a service connect complete message comprises:
if the base station controller receives a mobile origination message from the mobile station, sending a service request to a mobile switching center and then upon receiving a resource assignment request, requesting a base station transceiver subsystem to assign resources, and thus assigning resources;
upon reviewing service option information of the mobile station received at the base station controller through the base station transceiver subsystem and dormant timer information, if a packet data service option is indicated, preparing for determination on whether the mobile station supports the dormant function;
transmitting at the base station controller an expanded channel assignment message to the mobile station through the base station transceiver subsystem and then transmitting a service connection message to the mobile station; and
generating at the mobile station the service connect complete message, adding the dormant support information thereto and transmitting it to the base station controller.

18. The dormant control method according to claim 16, wherein said provision of the dormant function comprises:
analyzing at the base station controller the dormant support information included in the service connect complete message received from the mobile station;
if it is determined that the mobile station supports the dormant function, driving the dormant timer at the base station controller,
sending at the base station controller an interface registration request to a PDSN for transmission of signaling information and then receiving a response thereto and notifying the mobile switching center of the resource assignment completion;
establishing a PPP connection between the mobile station and the PDSN and conducting a mobile IP registration procedure, thus transmitting and receiving packet data in a active/connected state; and
determining at the base station controller whether the dormant timer is in operation and if no packet data has been transmitted within the specified value of the dormant timer, making a transition from the active/connected state to the dormant state.

19. The dormant control method in the packet data service network according to claim 18, wherein said provision of the dormant function further comprises, if it is determined that the mobile station does not support the dormant function, refraining at the base station controller from driving the dormant timer, thus maintaining the active/connected state.

20. A method for managing call processing in a packet data service network, comprising:
receiving a message from a mobile station, said message including information indicating whether the mobile station supports a dormant function; and
providing the dormant function based on the information in said message.

21. The method according to claim 20, wherein the dormant function is provided without determining a protocol standard of the mobile station.

22. The method according to claim 20, further comprising:
receiving service option information from the mobile station; and
determining whether the mobile station supports the dormant function if the service option information indicates a predetermined type of service.

23. The method according to claim 22, wherein the predetermined type of service is a packet data service.

24. The method according to claim 23, further comprising:
accessing the information in said message indicating whether the mobile station supports the dormant function in response to the determining step.

25. The method according to claim 20, wherein said message is a pre-existing message transmitted in the network, and the information indicating whether the mobile station supports the dormant function is included in a predetermined field of the pre-existing message.

26. The method according to claim 26, wherein the field is an unused field or a reserved field of pre-existing message.

27. The method according to claim 26, wherein said message is a service connect complete message.

28. The method according to claim 26, wherein said message is a state response message issued in response to a state request message issued from a base station controller

29. The method of claim 20, wherein said message is a special message created to indicate whether the mobile station supports the dormant function.
